(19) United States
(12) Patent Application Publication
(10) Pub. No.: US 2018/0225063 A1
(43) Pub. Date: Aug. 9, 2018

(54) DEVICE, SYSTEM AND METHOD TO PROVIDE CATEGORIZED TRACE INFORMATION

(71) Applicant: Intel IP Corporation, Santa Clara, CA (US)

(72) Inventors: Amit Kumar Singhvi, Bangalore (IN); Gerhard Hierl, Nuremberg (DE); Patrik Eder, Taufkirchen (DE); Christian Horak, Vaterstetten (DE)

(21) Appl. No.: 15/428,081

(22) Filed: Feb. 8, 2017

(51) Int. Cl. G06F 3/06

(52) U.S. Cl. CPC G06F 3/0656; G06F 3/0673; G06F 3/061

(57) ABSTRACT

Techniques and mechanisms to determine a selective buffering of various trace data to different respective buffers. In an embodiment, sort rules indicate trace data attributes that are each to correspond to a different respective buffer. The sort rules are enforced during a runtime session to concurrently sort different items of trace data, based on associated trace data attributes, for storage each to a corresponding buffer. In another embodiment, trigger rules are enforced during the runtime session to selectively debuffer only some trace data based on trigger conditions variously corresponding to different respective trace data types. In still another embodiment, enforcement of sort rules and/or trigger rules is modified during the runtime session to enable dynamic changes to the buffering or debuffering of trace data.

### BACKGROUND

### 1. Technical Field

Embodiments described herein relate generally to trace data collection mechanisms and more particularly, but not exclusively, to trace functionality of a system-on-chip.

### 2. Background Art

A system-on-chip (SoC) is one example of an integrated circuit that includes different components such as one or more processors, various homogeneous and/or heterogeneous processing agents, buses, hubs, routers, controllers, bridge devices, memories, and so forth. Trace information, accumulated during operation of such integrated circuitry, can be subsequently processed to evaluate performance characteristics.

Higher operating speeds of integrated circuits tend to result in a need for more runtime state information to be collected. However, such higher speeds pose challenges to the collection itself, and often results in an accumulation of large amounts of trace data which is not relevant to a given operational problem. Moreover, the design of a tracing system is impacted by the rate at which, and the extent to which, change takes place between successive generations of a given technology which is to use the tracing system.

As successive generations of integrated circuit technology continue to grow in number, variety and capability, both in terms of hardware and software, there is an increasing premium placed on tracing functionality which is effective to support debug and/or other evaluation processes.

### BRIEF DESCRIPTION OF THE DRAWINGS

The various embodiments of the present invention are illustrated by way of example, and not by way of limitation, in the figures of the accompanying drawings and in which:

FIG. 1 is a functional block diagram illustrating elements of a system to provide trace data according to an embodiment.

FIG. 2 is a flow diagram illustrating elements of a method for determining buffering of trace data according to an embodiment.

FIG. 3 is a functional block diagram illustrating elements of a system to provide, according to an embodiment, selective buffering and debuffering of trace data based on respective rules.

FIG. 4 is a flow diagram illustrating elements of a method to provide trace data according to an embodiment.

FIG. 5 shows types of rule information to variously provide a basis for determining trace data buffering according to corresponding embodiments.

FIG. 6 is a functional block diagram illustrating elements of a computer device according to an embodiment.

FIG. 7 is a functional block diagram illustrating elements of a computer system according to an embodiment.

### DETAILED DESCRIPTION

Embodiments described herein variously provide techniques or mechanisms to determine a selective buffering of trace data at one of a plurality of buffers. In an embodiment, sort rules are provided to variously indicate, for each buffer of the plurality of buffers, a respective trace data attribute that is to correspond to that buffer. Alternatively or in addition, trigger rules may be provided which indicate, for each trace data attribute of a plurality of trace data attributes, a respective condition that is to trigger a debuffering of trace data associated with that attribute. Enforcement of such sort rules and/or trigger rules may enable variety, across different trace data types, in the buffering of trace data and/or the debuffering of trace data—e.g., where such variety across trace data types is concurrent during a runtime session of a platform. In some embodiments, rule enforcement may be modified during a runtime session, thus enabling dynamic changes during system operation to the criteria by which different types of trace data are to be variously buffered and/or variously debuffered.

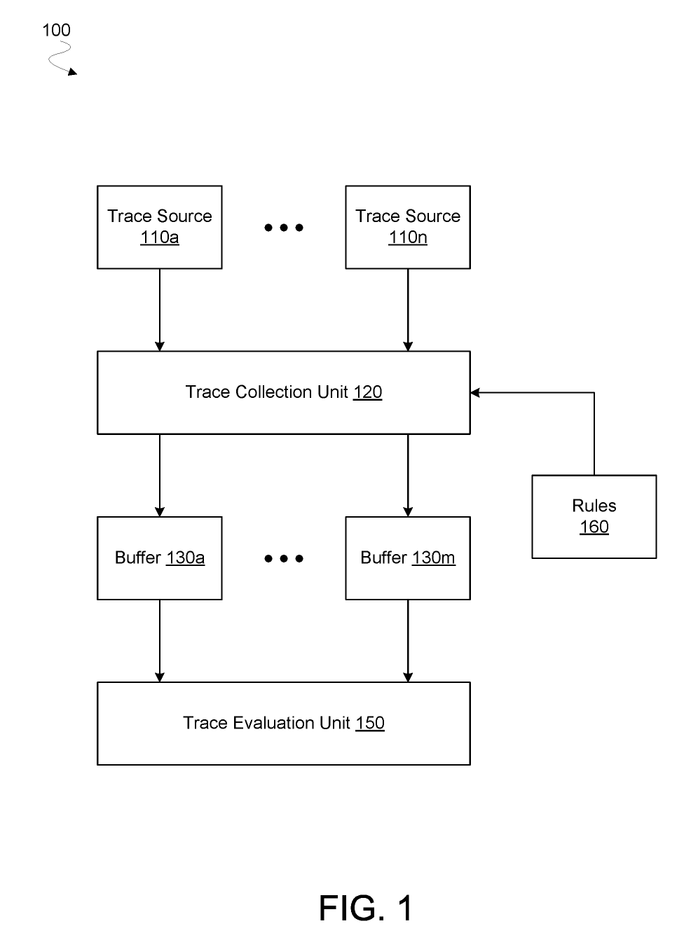

FIG. 1 illustrates elements of a system 100 to provide trace data according to an embodiment. System 100 is one example of an embodiment that operates to sort various information (referred to herein as “trace data”) for storing at different respective buffers. Some or all such buffered trace data may be subsequently processed to troubleshoot, diagnose or otherwise evaluate operation of system 100. In one embodiment, system 100 resides on or includes some or all of an IC chip which, for example, is to function as a system-on-chip (SoC). Alternatively or in addition, system 100 may some or all IC chips of a desktop computer, laptop computer, tablet device, smart phone or other such hardware platform.

The storing of trace data to different buffers by system 100 may be based on rules which correspond attributes, variously associated with respective trace data, each with a corresponding buffer of a plurality of buffers. For example, system 100 may comprise one or more resources, each such resource (referred to herein as “trace source”) to generate or otherwise provide trace data which describes or otherwise indicates state of the resource and/or state of circuitry associated with the resource. Such resources each reside in or on the same integrated circuit (IC) chip, for example. In another embodiments, some resources may be located in or on different respective IC chips—e.g., in different respective packaged devices of the same platform. Such resources may, for example, include a modem, bus, processor core, memory region, controller, power management circuit and/or any of a variety of other circuit components.

Trace data output by a given trace source may include data describing or otherwise indicating current state of that trace source. Such trace data may be subsequently evaluated—e.g., in combination with other trace data from the same trace source and/or trace data from another trace source—to perform diagnostics, troubleshooting and/or other system evaluation processes. The generation of various trace data by the one or more trace sources may include operations adapted from conventional trace techniques, which are not detailed herein and are not limiting on some embodiments.

In the illustrative embodiment shown, one or more trace sources of system 100 include trace sources 110a, . . . , 110n which are coupled to provide respective trace data to a trace collection unit 120. Trace collection unit 120 may include any of a variety of combinations of hardware, firmware and/or executing software to collect, sort and buffer trace data generated, for example, by trace sources 110a, . . . , 110n. For example, trace collection unit 120 may comprise one or more processors, application specific integrated circuits (ASICs), state machines, controllers, switches and/or other circuit logic operable to provide rule-based trace data sort functionality. Trace collection unit 120 may further include or couple to an interconnect architecture—e.g., including one or more buses, hubs, switches, latches and/or other circuitry—which facilitates receipt of trace data from respective ones of the one or more trace sources 110a, . . . , 110n.

Unless otherwise indicated, “rule” refers herein to information which defines or otherwise indicates a correspondence of a particular action with a respective condition—e.g., an event or state (such as a data attribute)—wherein the rule requires that the action is to take place in response to an instance of the corresponding condition. An action required by a rule may include, for example, a buffering of trace data or a debuffering of trace data. The action may be specific to only a subset of different trace data types—e.g., wherein the action is to buffer (or alternatively, to debuffer) only trace data which has, or is otherwise associated with, a particular attribute. It is to be understood that a condition—e.g., one that a rule corresponds to a particular action—may comprise a Boolean combination of multiple constituent conditions (or “sub-conditions”)—e.g., wherein a sub-condition may itself include another Boolean combination of constituent conditions (sub-sub-conditions), etc. Unless otherwise indicated, “condition” may refer to a single condition or a combination of sub-conditions that constitutes an aggregate condition. As described elsewhere herein, a condition, sub-condition, etc. may include an instance of one or more trace data attributes (e.g., including an instance of a particular Boolean combination of trace data attributes).

In an embodiment, a trace collocation unit 120 includes or couples to multiple buffers (e.g., including the illustrative buffers 130a, . . . , 130m shown). For some particular trace data, one or more attributes of that trace data may provide a basis for trace collocation unit 120 to determine a storing of such trace data to a particular buffer of buffers 130a, . . . , 130m. Such attribute-based sorting and buffering of trace data may be based on one or more rules (such as the illustrative rules 160 shown), some or all of which each define or otherwise indicate a correspondence of some one or more attributes with a respective buffer. At some time during runtime operation of system 100, a given one of rules 160 may be currently enforced or currently unenforced. For brevity, “enforced rule” refers herein to any rule that is currently being applied to determine whether and/or how at least some trace data is to be stored in a buffer. Similarly, “unenforced rule” refers herein to any rule that is currently not currently being applied to determine the buffering/debuffering of any trace data.

As used herein in the context of trace data, “trace data attribute” or “attribute” refers to a characteristic related to the communication of such trace data. An attribute may include a type of information which is represented by the trace data, a type of hardware from which the trace data originates, a path along which the trace data is communicated, a condition which resulted from, or resulted in, communication of the trace data, a frequency with which similar instances of the trace data are communicated and/or the like. An attribute may be explicitly identified by a trace source (e.g., in the trace data itself) or, alternatively, may be calculated or otherwise detected based on further sensing, calculating etc. at trace collection unit 120. In some embodiments, trace collection unit 120 supplements or otherwise modifies trace data based on detection of an associated attribute. For example, trace data may be stamped (e.g., appended or prepended) with metadata that, for example, identifies or otherwise indicates the rule or condition which is to be the basis for a subsequent buffering of such trace data.

An attribute of a given item of trace data (or “trace data item”) may be “scalar” in one or more respects—e.g., wherein the trace data item includes a parameter, the value of which is to represent or otherwise be associated with a position in some scale of severity, grading, ranking, order, priority or the like. Such a scale may be predefined by some reference information independent of the trace data item itself—e.g., wherein the scale assigns the respective importance of Debug, Validation, Info, Error and/or other classes of trace data relative to each other. In an embodiment, trace collocation unit 120 receives a class of trace data which is scalar with respect to one criteria/parameter, and further receives other trace data which is scalar with respect to a different criteria/parameter and/or which is buffered on the basis of some other non-scalar criteria/parameter. An attribute of trace data may be based on a relationship of a scalar value with a threshold scalar value, a range of accepted (or rejected) scalar values and/or the like.

An attribute of trace data may additionally or alternatively include or otherwise be based on the hardware that generates and/or is described by the trace data—e.g., wherein the attribute includes a merely generic device type to which the hardware belongs (e.g., memory, processor, controller or the like) or includes a device identifier which is specific to the hardware in particular. In some embodiments, an attribute of a trace data item includes one or more characteristics of a trace data stream (or other regular trace data communication) which provides the trace data item. By way of illustration and not limitation, an attribute of a trace data item may be a frequency/rate of a regular communication which includes the trace data. Alternatively or in addition, the attribute may include a change to such a frequency/rate over time, a hysteresis and/or other such characteristic of the regular communication. In an embodiment, such a characteristic of the regular communication may be predefined (e.g., statically) to trace collection unit 120. Alternatively or in addition, trace collection unit 120 may include or couple to circuitry to monitor for change or otherwise measure the characteristic.

Although some embodiments are not limited in this regard, system 100 may further comprise (or couple to) trace evaluation unit 150 which is to subsequently receive at least some trace data which has been buffered by trace collection unit 120. Trace evaluation unit 150 may include any of a variety of combinations of hardware, firmware, executing software and/or other logic to receive trace data and to generate an output which facilitates a determination of whether one or more circuit components of system 100 have failed to satisfy an operational test criteria. In some embodiments, the trace evaluation unit 150 performs processing of the trace data—e.g., including filtering, ordering, combining or otherwise arranging trace data for presentation in a trace report. Such a trace report may, for example, be stored in a memory, displayed with a display device and/or the like. Alternatively or in addition, trace evaluation unit 150 may perform calculations based on trace data—e.g., including comparing trace data with one or more predefined threshold values. In some embodiments, trace evaluation unit 150 is coupled to receive—e.g., from trace collection unit 120—information which describes or otherwise indicates a current correspondence of trace data attributes with respective ones of buffers 130a, . . . , 130m. Based on such information, trace evaluation unit 150 may explicitly request that trace data be debuffered from a selected one of buffers 130a, . . . , 130n. Evaluation of such trace data by trace evaluation unit 150 may include operations adapted from conventional system evaluation (e.g, debug) techniques, which are not detailed herein to avoid obscuring certain features of various embodiments.

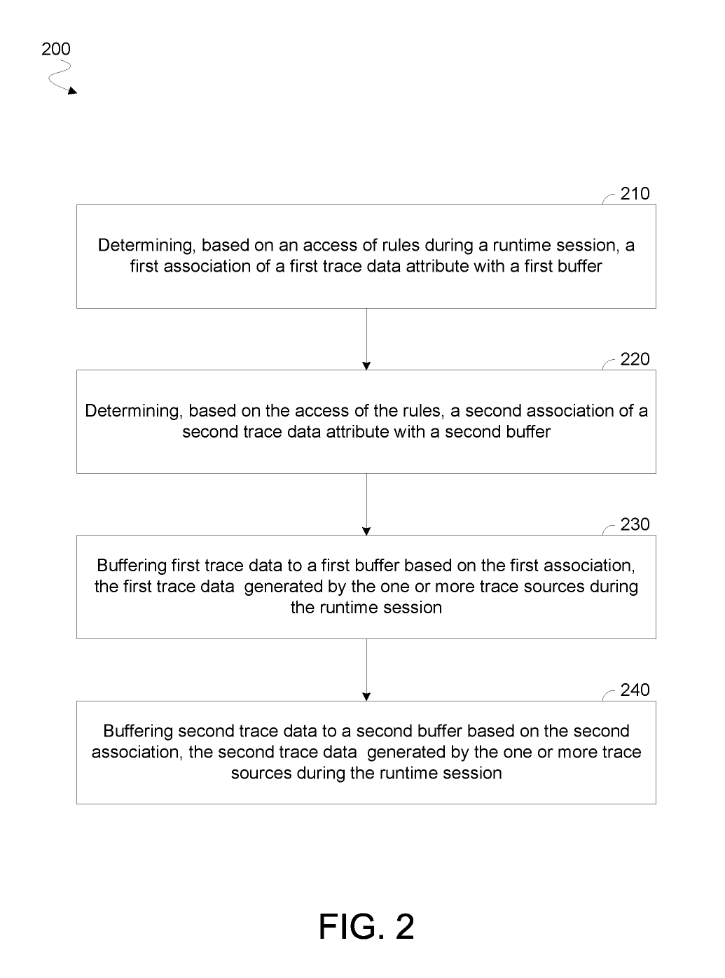

FIG. 2 illustrates elements of a method 200 to provide trace data according to an embodiment. Method 200 may be performed with at least some of system 100—e.g., wherein some or all operations of method 200 are performed by trace collection unit 120. In an embodiment, one or more operations of method 200 are performed during a runtime session which is executed by or otherwise performed with circuitry including the one or more trace sources—e.g., during runtime operation of a platform which comprises resources described by trace data provided by the one or more trace sources.

For example, method 200 may include, at 210, determining, based on rules accessed during the runtime session, a first association of a first trace data attribute with a first buffer. Method 200 may further comprise (at 220) determining, based on the rules accessed during the runtime session, a second association of a second trace data attribute with a second buffer.

Referring again to system 100, the determining at 210 and at 220 may include trace collection unit 120 accessing a first rule and a second rule (of rules 160) which variously specify or otherwise indicate, respectively, the first association and the second association. For brevity, a rule which requires the buffering of a particular trace data type to a particular buffer is referred to herein as a “sort rule.” In such an embodiment, the determining at 210 and/or 220 may further include or otherwise be based on a determination that a first sort rule and a second sort rule are currently being enforced—e.g., wherein one or both such rules may be unenforced at another time during the runtime session. For example, trace collection unit 120 may include or otherwise have access to reference information—e.g., stored in a table, bitmap, mode register or other data structure—which it uses to identify one or more rules each as being either currently enforced or currently unenforced. Such reference information may be regularly polled or otherwise accessed to detect for any changes to the enforcement of sort rules and/or other rules.

In an embodiment, method 200 further comprises, at 230, buffering first trace data to a first buffer based on the first association and, at 240, buffering second trace data to a second buffer based on the second association. The first trace data and the second trace data may be generated by the one or more trace sources—e.g., by different respective trace sources—during the runtime session. As a result of the buffering at 230 and 240, the first trace data and the second trace data may be concurrently maintained at the first buffer and the second trace data, respectively. One or each of the first buffer or the second buffer may, for example, include a respective one of a first-in-first-out (FIFO) buffer, a circular buffer (e.g., to provide overwriting operation or one-shot operation) or any of a variety of other suitable buffer types. However, some embodiments are not limited with respect to the particular type(s) of the multiple buffers to which respective trace data items are variously stored.

Of the first buffer and the second buffer, a first sort rule indicating the first association may (for example) require storage of trace data to only the first buffer—e.g., wherein, of the first buffer and the second buffer, a second sort rule may require storage of trace data to only the second buffer. As a result, any buffering of the first trace data at 230 based on the first association may be to store the first trace data to only one or more resources other than the second buffer. Alternatively or in addition, any buffering of the second trace data at 240 based on the second association may be to store the second trace data to only one or more resources other than the first buffer.

Some embodiments allow for the various enforcement of one or more rules to be updated dynamically—e.g., automatically—during the runtime session. By way of illustration and not limitation, rules 160 (for example) may be stored in a random access memory (RAM) which is coupled to an agent operable to update one or more rules and/or information to specify whether or not a rule is to be enforced during a particular condition (e.g., at a particular time).

In such an embodiment, method 200 may include one or more additional or alternative operations (not shown) that include or are based on a modifying of rule enforcement. For example, such operations may include modifying, during the runtime session, an enforcement of a first sort rule which indicates an association of a trace data attribute with one of multiple buffers including the first buffer and the second buffer. Such modifying of an enforcement of the first sort rule may include modifying the first sort rule during the runtime session—e.g., to change a condition (e.g., a trace data attribute) and/or an action indicated by the sort rule.

Alternatively or in addition, modifying the enforcement of the first sort rule includes signaling during the runtime session that enforcement of the first sort rule is to commence or stop. By way of illustration and not limitation, reference information may define or otherwise refer to a set of rule information (referred to herein as a “profile”) which comprises a first plurality of rules—e.g., including the first sort rule. In such an embodiment, signaling that enforcement of the first sort rule is to commence or stop may include signaling that enforcement/application of the first profile (and thus, enforcement/application of each of the first plurality of rules) is to commence or stop. In some embodiments, reference information may define or otherwise indicate another type of rule (referred to herein as an “enforcement rule”) which defines or otherwise indicates a condition under which enforcement of a target rule or profile is to automatically commence or automatically stop. For example, a first enforcement rule may indicate a correspondence of the condition with the first sort rule specifically or (in another embodiment) a correspondence of the condition with a profile which includes the first sort rule. In such an embodiment, signaling that enforcement of the first sort rule is to commence or stop may be based on both the first enforcement rule and detection of an instance of the condition.

In an embodiment where enforcement of rules may variously change during the runtime session, method 200 may further comprise buffering trace data based on such changed enforcement. For example, method may perform determining and buffering similar to that of operations at 210, 220, 230, 240, wherein a later association of some third trace data attribute (other than the first trace data attribute) with the first buffer is to be a basis for determining whether and/or where third trace data is to be buffered.

In some embodiments, method 200 may additionally or alternatively include other operations (not shown) to implement rule-based debuffering of trace data—e.g., from one or both of the first buffer and the second buffer. Such other operations may include detecting an instance of a condition which, as set forth in another type of rule (referred to herein as a “trigger rule”), is to result in a debuffering of trace data from at least one buffer.

Trigger rules may correspond a condition (e.g., an event or an occurrence of a predefined state) to some particular type of buffered trace data, wherein enforcement of the trigger rule includes requiring that such trace data be debuffered in response to the condition. The condition may, for example, include a Boolean combination of sub-conditions (e.g., one or more of which comprise respective sub-sub-conditions, etc.). In an embodiment, a condition of a trigger rule may include an attribute associated with trace data to be debuffered, an amount of data currently in one or more buffers, a rate of change of buffered data and/or any of a variety of one or more events and/or characteristics of system state. Like sort rules, trigger rules (and/or enforcement thereof) may be modified during a runtime session, in some embodiments. As a result, the determining of whether/how to buffer and/or debuffer various types of trace data may change dynamically, in some embodiments.

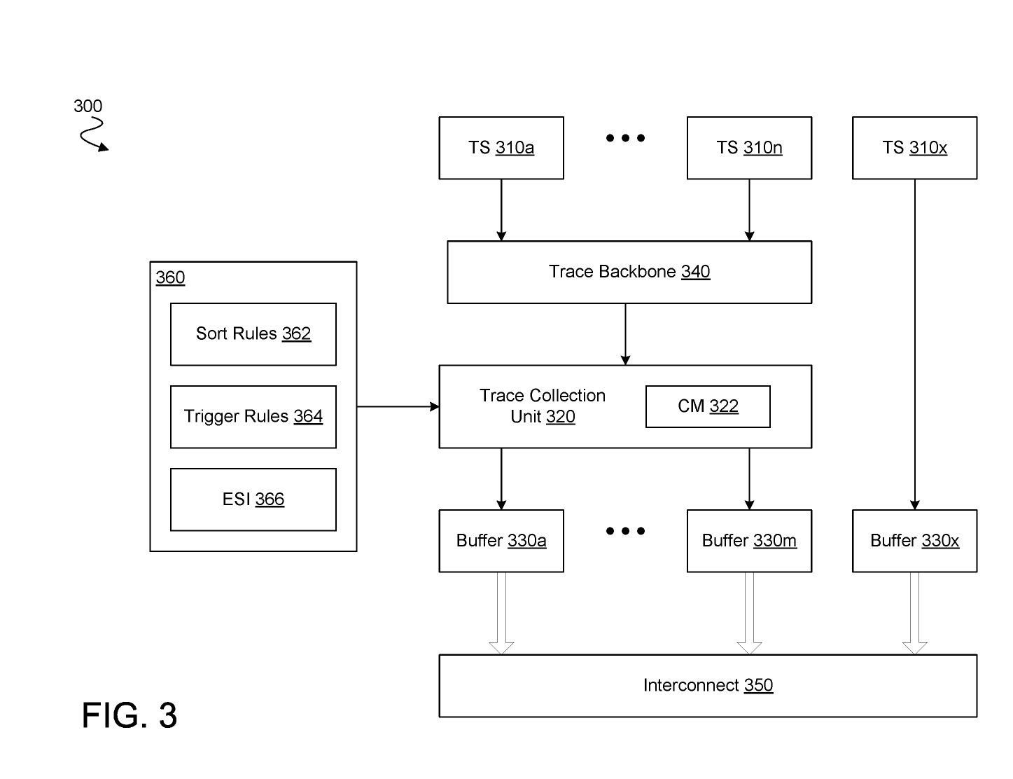

FIG. 3 illustrates elements of a device 300 to provide trace data according to an embodiment. Device 300 may include features of system 100, for example. In an embodiment, some or all operations of method 200 are performed at device 300.

In the illustrative embodiment shown, device 300 includes trace sources TS 310a, . . . , TS 310n and buffers 330a, . . . , 330m which, for example, correspond functionally trace sources 110a, . . . , 110n and buffers 130a, . . . , 130m, respectively. Device 300 may further comprise a trace collection unit 320 (e.g., having some or all of the features of trace collection unit 120) which is coupled via a trace backbone 340 to variously receive respective trace data from TS 310a, . . . , 310n.

Trace collection unit 320 may perform rule-based processing to determine the buffering of trace data to respective ones of buffers 330a, . . . , 330m—e.g., wherein such determining includes determining whether to buffer, where to buffer, when to debuffer, what to debuffer, etc. Such processing may be based on one or more sort rules, trigger rules, profiles and/or enforcement rules. In the illustrative embodiment shown, trace collection unit 320 is coupled to a repository 360—e.g., comprising a random access memory resource—having stored therein sort rules 362, trigger rules 364 and enforcement status information (ESI) 366 which specifies or otherwise indicates which of sort rules 362 and trigger rules 364 are currently enforced (or currently unenforced). During runtime operation of device 300, repository 360 may be accessed by a host processor or other agent to update some or all of sort rules 362, trigger rules 364 and ESI 366. Updates to rule information, such as that stored in repository 360, may be provided as an a priori input. The particular techniques by which such an input might be generated and communicated to device 300 may vary according to implementation-specific details, and are not limiting on some embodiments.

Trace collection unit 320 may include or couple to circuitry (such as the illustrative configuration manager CM 322 shown) which is to selectively configure one mode of a plurality of modes of trace collection unit 320. The configured mode may provide for trace data buffering which is according to any and all rules that, per ESI 366, are currently to be enforced. For example, CM 322 may regularly poll repository 360 for any updates to rules and/or rule enforcement. Alternatively or in addition, updates to rule information may be pushed to trace collection unit 320 automatically. In response to detecting that rule enforcement is to be updated, CM 322 may transition trace data sorting circuitry of trace collection unit from one mode to another mode.

Over time, some or all of buffers 330a, . . . , 330m may accrue various trace data which is associated with different respective attributes. In an embodiment, trace collection unit 320 further comprises circuitry to monitor for one or more conditions which, per a currently enforced one of trigger rules 364, is to result in at least some trace data being debuffered from one of buffers 330a, . . . , 330m. Based on a currently enforced trigger rule, and the detection of a condition indicated by that trigger rule, trace collection unit 320 may signal one of buffers 330a, . . . , 330m to output at least some buffered trace data. In one embodiment, buffers 330a, . . . , 330m are coupled to variously output—e.g., via the illustrative interconnect 350 shown—respective trace data that, for example, is to be subsequently received by trace evaluation circuitry (not shown).

Although some embodiments are not limited in this regard, device 300 may further comprise one or more buffers which are dedicated—e.g., permanently—to buffer trace data independent of sort rules 362. By way of illustration and not limitation, device 300 may further comprise a trace source 310x and a buffer 330x which is hardwired to receive trace data generated by trace source 310x—e.g., regardless of a current state of ESI 366. In other embodiments, device 300 may omit trace source 310x and buffer 330x.

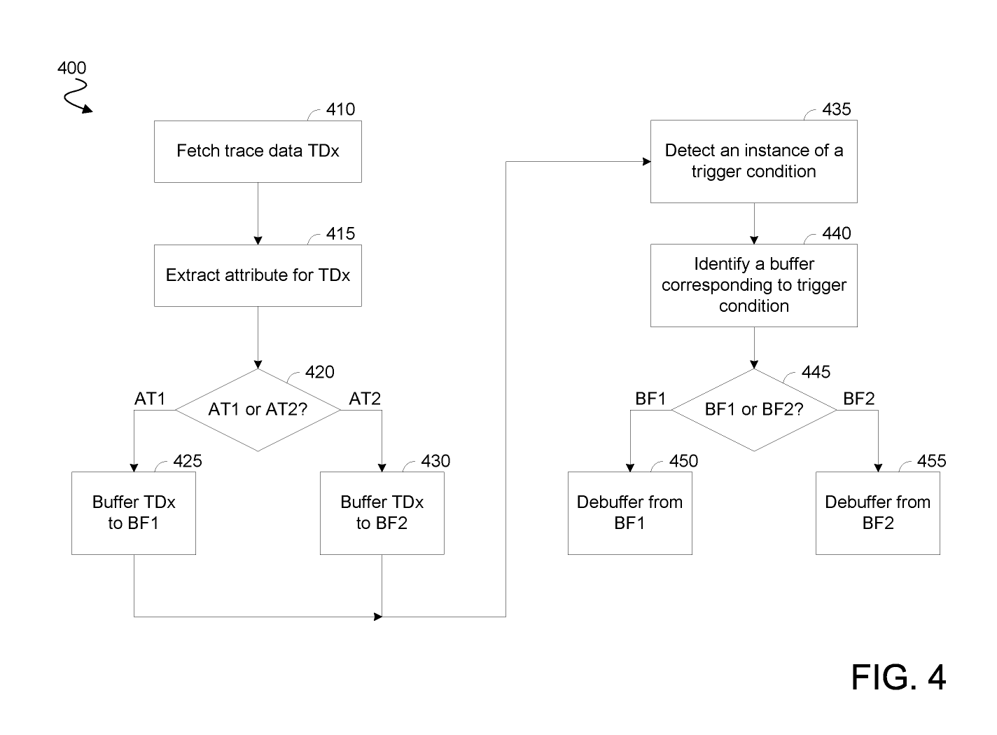

FIG. 4 illustrates elements of a method 400 to provide trace data according to an embodiment. Method 400 may be performed at one of system 100 and device 300—e.g., wherein some or all operations of method 200 are performed by one of trace collection units 120, 320. In an embodiment, one or more operations of method 200 are performed during a runtime session performed with one or more trace sources.

For example, method 400 may include, at 410, fetching trace data TDx which is generated by one or more trace sources during a session of runtime operation by a device (e.g., an SoC, a computer platform or the like which includes the one or more trace sources). In response to the fetching, method 400 may perform rule-based sorting to selectively determine whether and/or how TDx is to be buffered. Alternatively or in addition, method 400 may perform rule-based processing to selectively determine whether trace data such as TDx might subsequently be debuffered. Such rule-based buffering and/or debuffering may be based on one or more attributes associated with TDx—e.g., including an attribute of the communication of TDx.

For example, method 400 may further comprise, at 415, extracting an attribute which is associated with TDx. The fetching at 415 may include, for example, determining the attribute based at least in part on an evaluation of one or more values which are included in TDx. Alternatively or in addition, the fetching at 415 may include identifying a specific component which generated or otherwise participated in communication of the TDx (and/or identifying a hardware type of such a component). In some embodiments, the fetching at 415 includes detecting a characteristic of multiple communications including the communication of TDx. By way of illustration and not limitation, TDx may be provided in a trace data stream or other regular communication of similar trace data items. In such an embodiment, the attribute of TDx may include a data rate, a rate of change, a hysteresis and/or any of a variety of other characteristics of the regular communication.

Based on the fetching at 415, method 400 may determine whether the attribute is one of a plurality of attributes which are to be applied each according to a respective rule of a plurality of currently enforced sort rules. In the illustrative embodiment of method 400, only two sorting rules are considered—i.e., a first sort rule requiring buffering to a first buffer BF1 based on AT1 and a second sort rule requiring buffering to a second buffer BF2 based on AT2. For example, method 400 may (at 420) determine whether the attribute fetched at 415 is either one of two attributes AT1, AT2. In other embodiments, method 400 may perform sorting, according to a larger number of sort rules, which variously selects between three or more buffers based on respective trace data attributes.

Where it is determined at 420 that AT1 is associated with TDx, method 400 may, at 425, buffer a version of TDx to BF1 according to the first sort rule (e.g., rather than buffering any version of TDx to BF2). Where it is instead determined at 420 that AT2 is associated with TDx, method 400 may, at 430, buffer a version of TDx to BF2 according to the second sort rule (e.g., rather than buffering any version of TDx to BF1). Although some embodiments are not limited in this regard, method 400 may supplement TDx, prior to the buffering at 425 or 430, with additional information which, for example, specifies or otherwise indicates when and/or why TDx has been so buffered. Such additional information may evaluation of a trace report which, for example, might be based on TDx being subsequently debuffered from one of BF1 and BF2.

In some embodiments, method 400 includes additional or alternative operations to provide selective rule-based debuffering of trace data. Such operations may, for example, determine whether or when TDx is to be flushed, reported out or otherwise debuffered from one of BF1 and BF2. In the illustrative embodiment shown, method 400 includes, at 435, detecting an instance of a trigger condition that, for example, is associated with a currently enforced trigger rule. The trigger condition may comprise the expiration of some predefined period of time, the exceeding of a threshold buffer level, an explicit request from a trace system user and/or any of a variety of other system events or states. Some embodiments are not limited with respect to a particular trigger condition that a trigger rule might define as a basis for debuffering trace data.

Method 400 may further identify, at 440, which buffer of a plurality of buffers (e.g., including BF1 and BF2) corresponds to the trigger condition which is detected at 435. The identifying at 440 may include accessing information identifying currently enforced trigger rules and retrieving a buffer identifier from a currently enforced trigger rule which also identifies the trigger condition detected at 435. In the illustrative embodiment of method 400, only two trigger rules are considered—i.e., a first trigger rule requiring debuffering from BF1 and a second trigger rule requiring debuffering from BF2. For example, method 400 may determine, at 445, whether the buffer identified at 440 is BF1 or BF2. In other embodiments, method 400 may perform debuffering, according to a larger number of currently enforced trigger rules, which variously selects between three or more buffers based on respective trigger conditions.

Where it is determined at 445 that the trigger condition corresponds to BF1, method 400 may, at 450, debuffer at least some trace data from BF1 according to the first trigger rule (e.g., rather than debuffering any trace data from BF2). Where it is instead determined at 445 that the trigger condition corresponds to BF2, method 400 may, at 455, debuffer at least some trace data from BF2 according to the second trigger rule (e.g., rather than debuffering any trace data from BF2). In some embodiments, a trigger rule specifies or otherwise indicates whether a debuffering of trace data in response to a corresponding trigger condition, is to simply flush such trace data (e.g., to make buffer space available) or whether the debuffered trace data is to be provided as an input for generating a trace report for subsequent evaluation. Accordingly, the debuffering at 450 (or the debuffering at 455) may include either flushing trace data or providing trace report information, as required by the corresponding trigger rule being enforced.

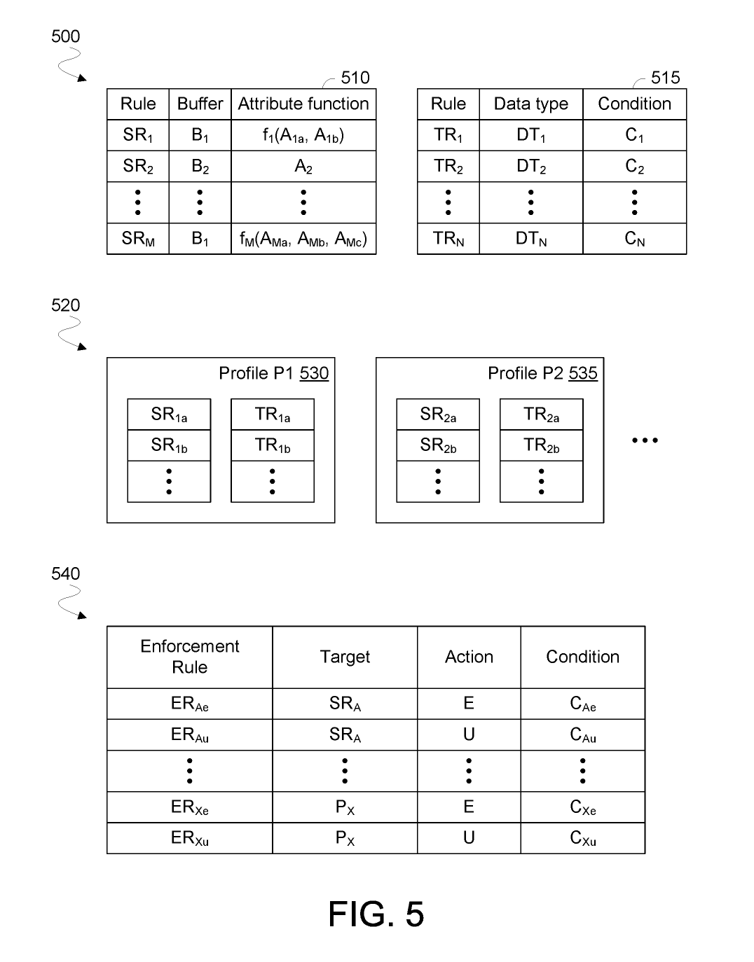

FIG. 5 shows various reference information, some or all of may be accessed to facilitate rule-base buffering and/or debuffering of trace data according to various embodiments. Reference information shown in FIG. 5 may include that of repository 360—e.g., wherein such reference information includes some or all of rules 160. In one embodiment, one of methods 200, 400 includes accessing (or is otherwise based on) such reference information.

Reference information 500 in FIG. 5 includes a table 510 of sort rules SR₁, SR₂, . . . , SR_{M} to variously determine sorting which facilitates trace data buffering according to an embodiment. In the illustrative embodiment shown, SR₁ identifies a correspondence of a buffer B₁ with an attribute function f₁(A₁ₐ, A_{1b}), representing—in this example—a trace data attribute comprising a particular combination of multiple constituent attributes A₁ₐ, A_{1b}. Enforcement of SR₁ may include detecting for trace data which is associated with a Boolean combination of attributes A₁ₐ, A_{1b} (the Boolean combination represented by the function f₁) and, in response to the instance, buffering such trace data to B₁. Similarly, enforcement of SR₂ may include detecting for trace data which is associated with an attribute A₂ and, in response to such a detecting, buffering the trace data in question to a buffer B₂.

In some embodiments, different sort rules may be enforced at different times, where such sort rules are to determine buffering of various trace data to the same buffer. By way of illustration and not limitation, enforcement of SR_{M} may include detecting for trace data which is associated with a Boolean combination f_{M}(A_{Ma}, A_{Mb}, A_{Mc}) of attributes A_{Ma}, A_{Mb}, A_{Mc} and, in response to such an detecting, buffering such trace data to the same buffer B₁ to which SR₁ also pertains. Sort rules SR₁, SR_{M} may thus be at least two options for determining selective buffering of trace data to B₁. In some embodiments, SR₁ and SR_{M} may be concurrently enforced—e.g., to buffer to B₁ any trace data which is associated with either or both of f₁(A₁ₐ, A_{1b}) and f_{M}(A_{Ma}, A_{Mb}, A_{Mc}).

Reference information 500 may additionally or alternatively include a table 515 of trigger rules TR₁, TR₂, . . . , TR_{N} to determine trace data debuffering. A trigger rule may define correspondence between a condition (e.g., including a system state or event) and a type of trace data that is to be debuffered in response to detection of an instance of such a condition. For example, enforcement of TR₁ may include detecting for an instance of a condition C₁ and, in response to such a detecting, debuffering trace data which of a data type DT₁. A data type such as DT₁ may, for example, directly or indirectly indicate one or more buffers—e.g., where enforcement of TR₁ is to debuffer some or all trace data currently stored one or more buffers that are specified or otherwise indicated by DT₁. Alternatively or in addition, enforcement of TR₂ may include detecting for an instance of another condition C₂ and, in response to such a detecting, debuffering trace data which of a data type DT₂. Similarly, enforcement of TR_{N} may include detecting for an instance of another condition C_{N} and, in response to such a detecting, debuffering trace data which of a data type DT_{N}

Reference information 520 in FIG. 5 includes two or more profiles, such as the illustrative P1 530, P2 535 shown, which each include a respective plurality of rules. A given profile may include one or more sort rules and/or one or more trigger rules—e.g., wherein commencing (or halting) the enforcement of the profile includes commencing (halting) the respective enforcement of each such rule of the profile.

Profiles P1 530, P2 535 may allow a manufacturer, vendor, administrator, user or other agent define sets of rules to be applied together—e.g., where the sets of rules are each to facilitate debug and/or other performance evaluation specific to a different respective use case or operational problem. By way of illustration and not limitation, P1 530 may include sort rules SR₁ₐ, SR_{1b} and trigger rules TR₁ₐ, TR_{1b}—e.g., where P2 535 includes sort rules SR₂ₐ, SR_{2b} and trigger rules TR₂ₐ, TR_{2b}. However, one or each of P1 530, P2 535 may include more, fewer and/or different rules, and some embodiments are not limited to the particular number and/or combination of sort rules and/or trigger rules of a given profile. In such an embodiment, a trace collection unit may be configured based on reference information 520 to transition from a first mode which is to enforce one of profiles P1 530, P2 535 to second mode which is to instead enforce the other of profiles P1 530, P2 535.

FIG. 5 also shows a table of enforcement rules 540 to facilitate automatic modification to the enforcement of one or more rules. An enforcement rule may identify or otherwise indicate a “target,” which in this context refers to one or more sort rules and/or one or more trigger rules to which the enforcement rule applies. Such a target may comprise only one sort rule or only one trigger rule, for example. Alternatively, the target may include a profile comprising a plurality of rules which includes one or more sort rules and/or one or more trigger rules. The enforcement rule may further specify a correspondence of the target with an action (which is to modify enforcement of the target) and with a condition, an instance of which is to result in the action. Application of an enforcement rule may include detecting for an instance of the condition and, in response to such detecting, commencing or halting enforcement of the target (depending on whether the action is to commence or halt such enforcement).

In the illustrative embodiment shown, an enforcement rule ER_{Ae} is to targets a sort rule SR_{A}, where ER_{Ae} defines a condition C_{Ae} which is to cause enforcement (E) of sort rule SR_{A}. Conversely, enforcement rule ER_{Au} also targets SR_{A}, except ER_{Au} defines a condition C_{Au} which is to cause an unenforcement (U) of SR_{A}. Alternatively or in addition, an enforcement rule ER_{Xe} may target a profile P_{X}, where ER_{Xe} defines a condition C_{Xe} which is to cause enforcement of P_{X}. Conversely, enforcement rule ER_{Xu} also targets P_{X}, except ER_{Xu} defines a condition C_{Xu} which is to cause enforcement of P_{X} to halt.

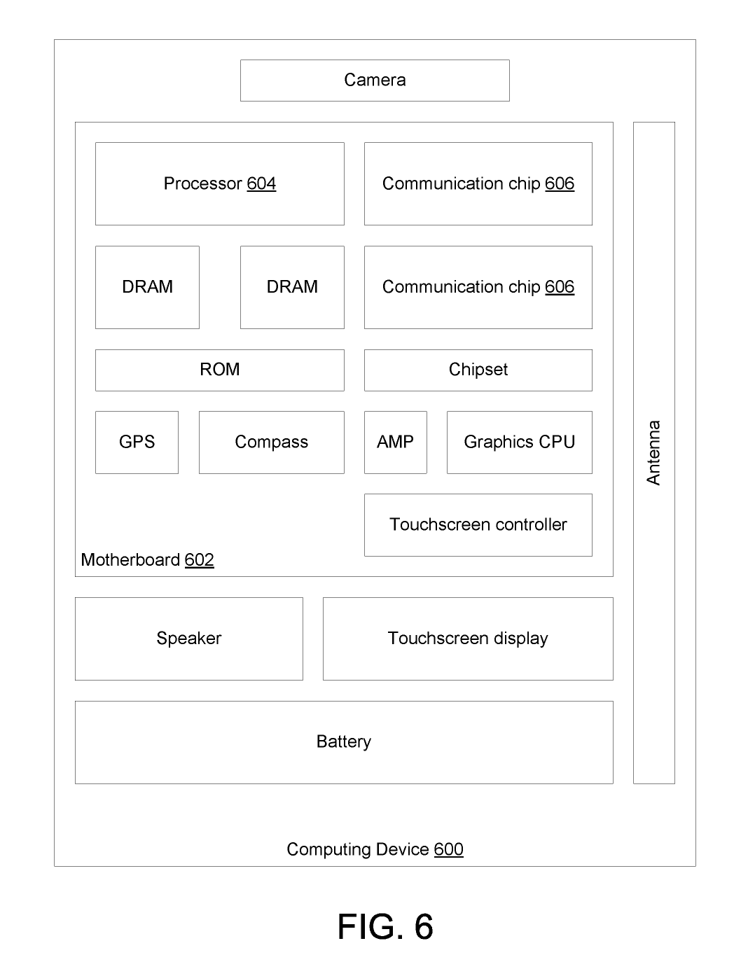

FIG. 6 illustrates a computing device 600 in accordance with one embodiment. The computing device 600 houses a board 602. The board 602 may include a number of components, including but not limited to a processor 604 and at least one communication chip 606. The processor 604 is physically and electrically coupled to the board 602. In some implementations, at least one communication chip 606 is also physically and electrically coupled to the board 602. In further implementations, the communication chip 606 is part of the processor 604.

Depending on its applications, computing device 600 may include other components that may or may not be physically and electrically coupled to the board 602. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 606 enables wireless communications for the transfer of data to and from the computing device 600. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 606 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 600 may include a plurality of communication chips 606. For instance, a first communication chip 606 may be dedicated to shorter range wireless communications such as Wi-Fi and Bluetooth and a second communication chip 606 may be dedicated to longer range wireless communications such as GPS, EDGE, GPRS, CDMA, WiMAX, LTE, Ev-DO, and others.

The processor 604 of the computing device 600 includes an integrated circuit die packaged within the processor 604. The term “processor” may refer to any device or portion of a device that processes electronic data from registers and/or memory to transform that electronic data into other electronic data that may be stored in registers and/or memory. The communication chip 606 also includes an integrated circuit die packaged within the communication chip 606.

In various implementations, the computing device 600 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 600 may be any other electronic device that processes data.

Some embodiments may be provided as a computer program product, or software, that may include a machine-readable medium having stored thereon instructions, which may be used to program a computer system (or other electronic devices) to perform a process according to an embodiment. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

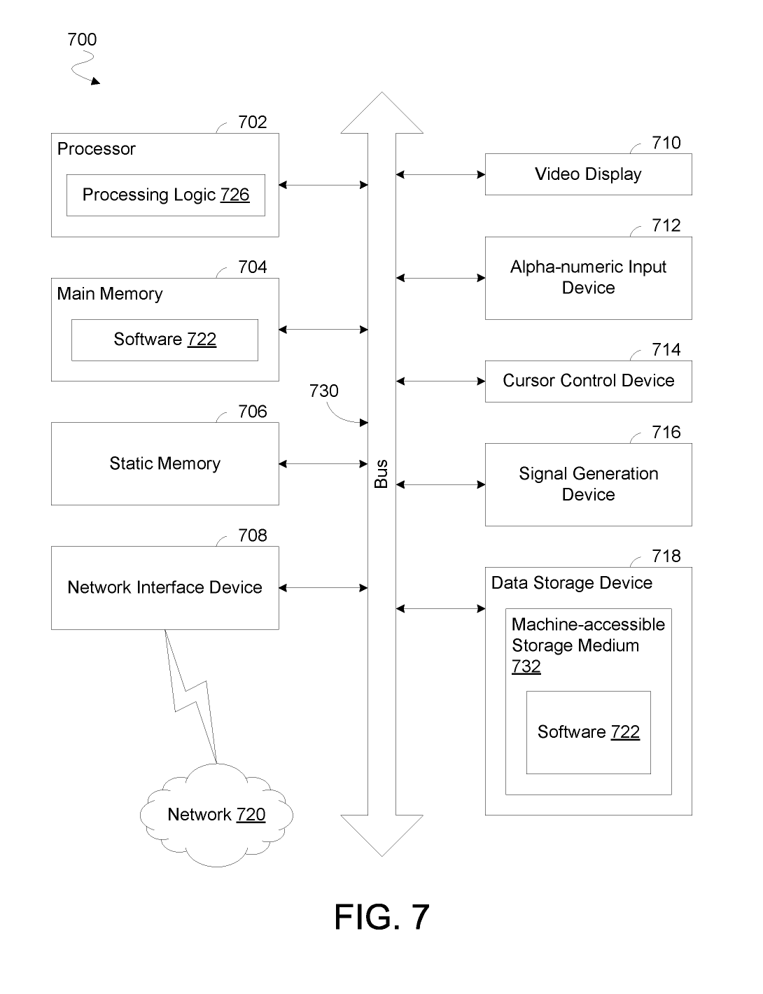

FIG. 7 illustrates a diagrammatic representation of a machine in the exemplary form of a computer system 700 within which a set of instructions, for causing the machine to perform any one or more of the methodologies described herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies described herein.

The exemplary computer system 700 includes a processor 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a secondary memory 718 (e.g., a data storage device), which communicate with each other via a bus 730.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 702 may also be one or more special-purpose processing devices such as an application specific integrated circuit (ASIC), a field programmable gate array (FPGA), a digital signal processor (DSP), network processor, or the like. Processor 702 is configured to execute the processing logic 726 for performing the operations described herein.

The computer system 700 may further include a network interface device 708. The computer system 700 also may include a video display unit 710 (e.g., a liquid crystal display (LCD), a light emitting diode display (LED), or a cathode ray tube (CRT)), an alphanumeric input device 712 (e.g., a keyboard), a cursor control device 714 (e.g., a mouse), and a signal generation device 716 (e.g., a speaker).

The secondary memory 718 may include a machine-accessible storage medium (or more specifically a computer-readable storage medium) 732 on which is stored one or more sets of instructions (e.g., software 722) embodying any one or more of the methodologies or functions described herein. The software 722 may also reside, completely or at least partially, within the main memory 704 and/or within the processor 702 during execution thereof by the computer system 700, the main memory 704 and the processor 702 also constituting machine-readable storage media. The software 722 may further be transmitted or received over a network 720 via the network interface device 708.

While the machine-accessible storage medium 732 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any of one or more embodiments. The term “machine-readable storage medium” shall accordingly be taken to include, but not be limited to, solid-state memories, and optical and magnetic media.

In one implementation, a device comprises a first buffer, a second buffer, and a trace collection unit including circuitry to receive first trace data and second trace data from one or more trace sources during a runtime session with the device, access rules during the runtime session and determine, based on the rules, a first association of a first trace data attribute with the first buffer and a second association of a second trace data attribute with the second buffer, buffer the first trace data to the first buffer based on the first association, and buffer the second trace data to the second buffer based on the second association, wherein the first trace data and the second trace data are to be concurrently at the first buffer and the second trace data, respectively.

In an embodiment, the trace collection unit further comprises a configuration manager including circuitry configured to modify, during the runtime session, an enforcement of a first rule of the rules, wherein the first rule indicates an association of a trace data attribute with one of multiple buffers including the first buffer and the second buffer. In another embodiment, the configuration manager is to modify the enforcement based on a modification of the first rule during the runtime session. In another embodiment, the configuration manager is to modify the enforcement in response to a signal which indicates that enforcement of the first rule is to commence or stop. In another embodiment, a first profile comprises a first plurality of rules including the first rule, and wherein the signal indicates that application of the first profile is to commence or stop. In another embodiment, a first enforcement rule defines a condition under which enforcement of the first rule is to automatically commence or automatically stop, wherein the signal is based on both the first enforcement rule and an instance of the condition. In another embodiment, the trace collection unit is further to detect an instance of a condition, wherein a trigger rule indicates a correspondence of the condition to a trace data type, identify, in response to the instance, one of the first buffer and the second buffer as corresponding to the data type, and debuffer trace data from the identified one of the first buffer and the second buffer.

In another implementation, a method comprises determining a first association of a first trace data attribute with a first buffer and a second association of a second trace data attribute with a second buffer, the determining based on an access of rules during a runtime session with the one or more trace sources, buffering first trace data to a first buffer based on the first association, and buffering second trace data to a second buffer based on the second association, the first trace data and the second trace data generated by the one or more trace sources during the runtime session, wherein the first trace data and the second trace data are concurrently at the first buffer and the second trace data, respectively.

In an embodiment, the method further comprises modifying, during the runtime session, an enforcement of a first rule of the rules, wherein the first rule indicates an association of a trace data attribute with one of multiple buffers including the first buffer and the second buffer. In another embodiment, modifying the enforcement includes modifying the first rule during the runtime session. In another embodiment, modifying the enforcement includes signaling during the runtime session that enforcement of the first rule is to commence or stop. In another embodiment, a first profile comprises a first plurality of rules including the first rule, and wherein signaling that enforcement of the first rule is to commence or stop includes signaling that application of the first profile is to commence or stop. In another embodiment, a first enforcement rule defines a condition under which enforcement of the first rule is to automatically commence or automatically stop, and wherein signaling that enforcement of the first rule is to commence or stop is based on both the first enforcement rule and an instance of the condition. In another embodiment, the method further comprises detecting an instance of a condition, wherein a trigger rule indicates a correspondence of the condition to a trace data type, identifying, in response to the instance, one of the first buffer and the second buffer as corresponding to the data type, and based on the identifying, debuffering trace data from the one of the first buffer and the second buffer.

In another implementation, a non-transitory computer-readable storage medium has stored thereon instructions which, when executed by one or more processing units, cause the one or more processing units to perform a method comprising determining a first association of a first trace data attribute with a first buffer and a second association of a second trace data attribute with a second buffer, the determining based on an access of rules during a runtime session with the one or more trace sources, buffering first trace data to a first buffer based on the first association, and buffering second trace data to a second buffer based on the second association, the first trace data and the second trace data generated by the one or more trace sources during the runtime session, wherein the first trace data and the second trace data are concurrently at the first buffer and the second trace data, respectively.

In an embodiment, the method further comprises modifying, during the runtime session, an enforcement of a first rule of the rules, wherein the first rule indicates an association of a trace data attribute with one of multiple buffers including the first buffer and the second buffer. In another embodiment, modifying the enforcement includes modifying the first rule during the runtime session. In another embodiment, modifying the enforcement includes signaling during the runtime session that enforcement of the first rule is to commence or stop. In another embodiment, a first profile comprises a first plurality of rules including the first rule, and wherein signaling that enforcement of the first rule is to commence or stop includes signaling that application of the first profile is to commence or stop. In another embodiment, a first enforcement rule defines a condition under which enforcement of the first rule is to automatically commence or automatically stop, and wherein signaling that enforcement of the first rule is to commence or stop is based on both the first enforcement rule and an instance of the condition. In another embodiment, the method further comprises detecting an instance of a condition, wherein a trigger rule indicates a correspondence of the condition to a trace data type, identifying, in response to the instance, one of the first buffer and the second buffer as corresponding to the data type, and based on the identifying, debuffering trace data from the one of the first buffer and the second buffer.

Techniques and architectures for providing categorized trace data are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A device comprising:
a first buffer;
a second buffer; and
a trace collection unit including circuitry to:
receive first trace data and second trace data from one or more trace sources during a runtime session with the device;
access rules during the runtime session and determine, based on the rules, a first association of a first trace data attribute with the first buffer and a second association of a second trace data attribute with the second buffer;
buffer the first trace data to the first buffer based on the first association; and
buffer the second trace data to the second buffer based on the second association, wherein the first trace data and the second trace data are to be concurrently at the first buffer and the second trace data, respectively.

2. The device of claim 1, the trace collection unit further comprising a configuration manager including circuitry configured to modify, during the runtime session, an enforcement of a first rule of the rules, wherein the first rule indicates an association of a trace data attribute with one of multiple buffers including the first buffer and the second buffer.

3. The device of claim 2, wherein the configuration manager to modify the enforcement based on a modification of the first rule during the runtime session.

4. The device of claim 2, wherein the configuration manager to modify the enforcement in response to a signal which indicates that enforcement of the first rule is to commence or stop.

5. The device of claim 4, wherein a first profile comprises a first plurality of rules including the first rule, and wherein the signal indicates that application of the first profile is to commence or stop.

6. The device of claim 4, wherein a first enforcement rule defines a condition under which enforcement of the first rule is to automatically commence or automatically stop, and wherein the signal is based on both the first enforcement rule and an instance of the condition.

7. The device of claim 1, the trace collection unit further to:
detect an instance of a condition, wherein a trigger rule indicates a correspondence of the condition to a trace data type;
identify, in response to the instance, one of the first buffer and the second buffer as corresponding to the data type; and
debuffer trace data from the identified one of the first buffer and the second buffer.

8. A method comprising:
determining a first association of a first trace data attribute with a first buffer and a second association of a second trace data attribute with a second buffer, the determining based on an access of rules during a runtime session with the one or more trace sources;
buffering first trace data to a first buffer based on the first association; and
buffering second trace data to a second buffer based on the second association, the first trace data and the second trace data generated by the one or more trace sources during the runtime session, wherein the first trace data and the second trace data are concurrently at the first buffer and the second trace data, respectively.

9. The method of claim 8, further comprising:
modifying, during the runtime session, an enforcement of a first rule of the rules, wherein the first rule indicates an association of a trace data attribute with one of multiple buffers including the first buffer and the second buffer.

10. The method of claim 9, wherein modifying the enforcement includes modifying the first rule during the runtime session.

11. The method of claim 9, wherein modifying the enforcement includes signaling during the runtime session that enforcement of the first rule is to commence or stop.

12. The method of claim 11, wherein a first profile comprises a first plurality of rules including the first rule, and wherein signaling that enforcement of the first rule is to commence or stop includes signaling that application of the first profile is to commence or stop.

13. The method of claim 11, wherein a first enforcement rule defines a condition under which enforcement of the first rule is to automatically commence or automatically stop, and wherein signaling that enforcement of the first rule is to commence or stop is based on both the first enforcement rule and an instance of the condition.

14. The method of claim 8, further comprising:
detecting an instance of a condition, wherein a trigger rule indicates a correspondence of the condition to a trace data type;
identifying, in response to the instance, one of the first buffer and the second buffer as corresponding to the data type; and
based on the identifying, debuffering trace data from the one of the first buffer and the second buffer.

15. A non-transitory computer-readable storage medium having stored thereon instructions which, when executed by one or more processing units, cause the one or more processing units to perform a method comprising:
determining a first association of a first trace data attribute with a first buffer and a second association of a second trace data attribute with a second buffer, the determining based on an access of rules during a runtime session with the one or more trace sources;
buffering first trace data to a first buffer based on the first association; and
buffering second trace data to a second buffer based on the second association, the first trace data and the second trace data generated by the one or more trace sources during the runtime session, wherein the first trace data and the second trace data are concurrently at the first buffer and the second trace data, respectively.

16. The computer-readable storage medium of claim 15, the method further comprising:
modifying, during the runtime session, an enforcement of a first rule of the rules, wherein the first rule indicates an association of a trace data attribute with one of multiple buffers including the first buffer and the second buffer.

17. The computer-readable storage medium of claim 16, wherein modifying the enforcement includes modifying the first rule during the runtime session.

18. The computer-readable storage medium of claim 16, wherein modifying the enforcement includes signaling during the runtime session that enforcement of the first rule is to commence or stop.

19. The computer-readable storage medium of claim 18, wherein a first profile comprises a first plurality of rules including the first rule, and wherein signaling that enforcement of the first rule is to commence or stop includes signaling that application of the first profile is to commence or stop.

20. The computer-readable storage medium of claim 18, wherein a first enforcement rule defines a condition under which enforcement of the first rule is to automatically commence or automatically stop, and wherein signaling that enforcement of the first rule is to commence or stop is based on both the first enforcement rule and an instance of the condition.

21. The computer-readable storage medium of claim 15, the method further comprising:
detecting an instance of a condition, wherein a trigger rule indicates a correspondence of the condition to a trace data type;
identifying, in response to the instance, one of the first buffer and the second buffer as corresponding to the data type; and
based on the identifying, debuffering trace data from the one of the first buffer and the second buffer.
